(19) United States
(12) Patent Application Publication
(10) Pub. No.: US 2007/0050829 A1
(43) Pub. Date: Mar. 1, 2007

(54) Data transmitter and receiver, data transmitting/receiving system and method, and terminal device

(76) Inventors: Shuji Asami, Shizuoka (JP); Masao Kobayashi, Nagano (JP)

Correspondence Address: Pamela R. Crocker;Patent Legal Staff, Eastman Kodak Company, 343 State Street, Rochester, NY, 14650-2201, US

(21) Appl. No.: 11/360,643

(22) Filed: Feb. 23, 2006

(30) Foreign Application Priority Data
Aug. 31, 2005 (JP) 2005-252163

(51) Int. Cl. H04N 7/173

(52) U.S. Cl. 725/105

(57) ABSTRACT

In order to efficiently transmit captured image data to a server using multiple digital cameras having a communication function, a plurality of digital cameras constitute a group with a master function allocated to the digital camera. Each of the digital cameras includes a plurality of communication units. The digital camera divides into three segments image data to be transmitted (uploaded) to a server, and allocates two of the three segments to the digital cameras, respectively. The digital camera transmits the allocated segments of image data to the digital cameras. The digital camera transmits to the server the one of the three segments allocated to the digital camera, and issues a transfer request to the digital cameras. The digital cameras transmit the received image data to the server according to the transfer request.

### FIELD OF THE INVENTION

The present invention generally relates to a data transmitter, a data receiver, and the like, and more particularly to a technique for dividing data such as image data and the like and transmitting and receiving the divided data.

### BACKGROUND OF THE INVENTION

Conventionally, there has been known a technique for transmitting an image captured by a digital camera to a server via a communication network to thereby store the transmitted image in the server.

For example, Japanese Patent Laid-Open Publication No. 2004-194187 discloses a technique for connecting an imaging unit such as a digital camera or the like to a network, dividing a whole image according to the transmission bandwidth of the network, and transmitting the divided images to a server via the network.

The division of the whole image into multiple images to be transmitted enables reliable transmission of the image data to the server even if the communication band is narrow; however, the technique has a problem in that transmitting the whole image to the server requires a long time.

Meanwhile, in the field of information processing using a computer, there has been conducted a trial in which processing time is shortened by means of grid computing, in which multiple computers are mutually connected and carry out simultaneous, parallel processing of a task or a job, and a certain result has been attained. Accordingly, desire has arisen to shorten processing time by skillfully using such a method also in case of transmitting, to a server, image data obtained by an imaging apparatus such as a digital camera or the like.

### SUMMARY OF THE INVENTION

An object of the present invention is to provide an apparatus and method which can quickly transmit and receive image data and other data to and from a server.

In order to attain the object, the present invention provides a data transmitter which transmits to a server data stored in a memory, comprising: a divider which divides the data into segments which are equal in number to the number of data transmitters including the data transmitter itself and other grouped data transmitters; and a transmission controller which causes the data transmitter to transmit to each of the other data transmitters a segment of data allocated thereto respectively using a first communication method, causes the data transmitter itself to transmit a segment of data allocated thereto to the server using a second communication method, and transmits to the other data transmitters a command signal which requests each of the other data transmitters to transmit to the server the segment of data transmitted thereto using the second communication method.

Moreover, the present invention provides a data receiver which receives data stored in a server, comprising: a division request unit which requests the server to divide the data into segments which are equal in number to the number of data receivers including the data receiver itself and other grouped data receivers; and a reception controller which causes the data receiver itself to obtain from the server a segment of data allocated thereto, transmits, to each of the other data receivers, a command signal which requests each of the other data receivers to obtain the segment of data allocated thereto from the server, and obtains from each of the other data receivers, the segment of data obtained by each of the other servers in accordance with the command signal, wherein a first communication method is used at the time of obtaining the segments of data from the other data receivers, and a second communication method is used at the time of obtaining from the server the segment of data self-allocated to the data receiver itself.

Moreover, the present invention provides a data transmission system which transmits data to a server by means of a plurality of data transmitters, wherein any of the plurality of data transmitters is used as a master, and the other data transmitters are used as slaves; the master includes: a divider which divides the data into segments which are equal in number to the number of data transmitters including the master and the slaves; and a master side transmission controller which causes the master to transmit to each of the slaves a segment of data divided by the divider and allocated thereto respectively using a first communication method, causes the master to transmit a segment of data allocated thereto to the server using a second communication method, and transmits to the slaves a command signal which requests each of the slaves to transmit to the server the segment of data transmitted thereto; and each of the slaves includes: a slave side storage unit which stores a segment of data allocated by the master; and a slave side transmission controller which causes the slave to transmit, to the server, the data stored in the slave side storage using the second communication method in accordance with the command signal transmitted from the master.

Moreover, the present invention provides a data reception system which receives data from a server by means of a plurality of data receivers, wherein any of the plurality of data receivers is used as a master, and the other data receivers are used as slaves; the master includes: a division request unit which requests the server to divide the data into segments which are equal in number to the number of data receivers including the master and the slaves; and a reception controller which transmits to each of the slaves, using a first communication method, a command signal which requests each of the slaves to obtain a segment of data allocated thereto from the server, causes the master to receive, using the first communication method, the segment of data which each of the slaves has received from the server in accordance with the command signal, and causes the master to receive, using a second communication method, a segment of data self-allocated to the master which has been transmitted from the server; and each of the slaves includes: a slave side storage unit which stores a segment of data received from the server using the second communication method in accordance with the command signal.

Moreover, the present invention provides a data transmission method which transmits data to a server by means of a plurality of data transmitters, comprising the steps of: using any of the plurality of data transmitters as a master, and dividing the data to be transmitted into segments which are equal in number to the number of the plurality of data transmitters to thereby allocate a segment of the data to each of the data transmitters; the master transmitting to each of the data transmitters other than the master a segment of data allocated thereto using a first communication method and transmitting a segment of data self-allocated to the master to the server using a second communication method; and each of the data transmitters other than the master transmitting using the second communication method, to the server, the segment of data which has been allocated to the data transmitter and has been received from the master.

Moreover, the present invention provides a data reception method which receives data from a server by means of a plurality of data receivers, comprising the steps of: using any of the plurality of data receivers as a master and requesting the server to divide the data into segments which are equal in number to the number of the data receivers including the master and slaves; and the master receiving using a first communication method, from each of the data receivers other than the master, a segment of data which has been received from the server, and receiving, from the server, a segment of data self-allocated to the master using a second communication method.

According to the present invention, because the plurality of transmitters transmit the divided segments of data simultaneously, or because the plurality of data receivers receive the divided segments of data from the server simultaneously, the transmission or reception of the data is completed in a short time. Moreover, because the first communication method is used for the communication among each of the plurality of data transmitters or among each of the plurality of data receivers, and because the second communication method different from the first communication method is used for the communication between a data transmitter or a data receiver and the server, the transmission and reception time of data can be shortened even if the communication speed of the second communication method is relatively low. The present invention can be also said to attain improvement in the efficiency of data transmission and reception by skillfully combining the first communication method and the second communication method, which have different communication characteristics. Applying the present invention to a digital camera enables cooperative operation of multiple digital cameras to upload captured image data and the like to a server, or to download the captured image and the like from the server.

### BRIEF DESCRIPTION OF THE DRAWINGS

Preferred embodiments of the present invention will be described in detail by reference to the following figures, wherein:

FIG. 1 is a configuration diagram of a digital camera;

FIG. 2 is an explanatory diagram of the establishment of connection of multiple digital cameras;

FIG. 3 is the system configuration diagram of a first embodiment;

FIG. 4 is an explanatory diagram of a division operation;

FIG. 5 is the directory structure diagram of each digital camera at the time of segment transmission;

FIG. 6 is an explanatory diagram of a “DST” file in FIG. 5;

FIG. 7 is a flowchart of the transmission processing of a digital camera 10;

FIG. 8 is the system configuration diagram of a second embodiment;

FIG. 9 is the directory structure diagram of each digital camera and a server at the time of data segment reception;

FIG. 10 is an explanatory diagram of an “SRC” file in FIG. 8; and

FIG. 11 is the system configuration diagram of a third embodiment.

### DETAILED DESCRIPTION OF THE PREFERRED INVENTION

In the following, the embodiments of the present invention are described by reference to the drawings. In the present embodiment, an example is described. In the example, multiple digital cameras form one group; a captured image stored in the memory of a certain digital camera is divided into segments to be allocated to the respective member cameras in the group; and each of these segments of the image data is transmitted to a server from each of the member cameras in the group respectively.

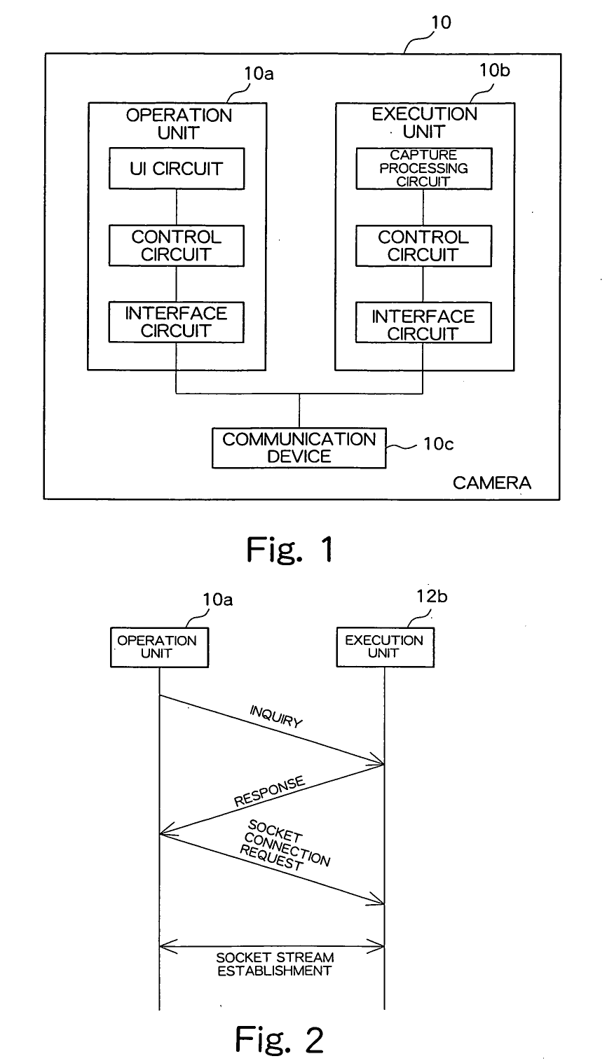

FIG. 1 shows a configuration block diagram of a digital camera 10 which has a communication function according to the present embodiment. The digital camera 10 is composed of an operation unit 10a, an execution unit 10b, and a communication device 10c. The operation unit 10a is a user interface (UI) component which carries out a mutual communication with a user, and performs UI control of an operation button used by the user when the user operates the digital camera 10. The operation unit 10a is specifically provided with a UI circuit, a control circuit, and an interface circuit. The execution unit 10b is a component which integrates the functions of the digital camera 10 such as image capturing, image data storage, and the like, and is specifically provided with an image capture processing circuit, a control circuit, and an interface circuit. The operation unit 10a and the execution unit 10b communicate with each other using a general purpose communication protocol through the interface circuits. In the present embodiment, Picture Transfer Protocol (PTP) is used as the mounted protocol of the interface circuit, and TCP/IP is used for the communication protocol used as the basis of the interface. The operation unit 10a and the execution unit 10b communicate with each other by exchanging PTP commands and their responses through a socket stream, which is a communication path. The communication device 10c is a component for performing communication with other digital cameras and the like through a network.

As a single body, the control circuit in the digital camera 10 receives an operation instruction from a user through the UI circuit, and the control circuit outputs a control signal according to the operation instruction to the execution unit 10b, through the interface. The control circuit of the execution unit 10b receives the control signal from the operation unit 10a through the interface circuit, and controls the image capture processing circuit according to the control signal to perform image capture processing. Meanwhile, when another digital camera-denoted as a digital camera 12 exists in addition to the digital camera 10, a communication path is established between the operation unit 10a of the digital camera 10 and the execution unit 12b of the digital camera 12. This digital camera 12, is also assumed to include an operation unit 12a, an execution unit 12b, and a communication device 12c, similar to the digital camera 10.

The process for establishment of the communication path between the operation unit 10a of the digital camera 10 and the execution unit 12b of the digital camera 12 is shown in FIG. 2. After the operation unit 10a has recognized the communication device 12c of the digital camera 12, the operation unit 10a transmits an inquiry packet to the communication device 12c in order to find the execution unit 12b. For example, a UDP packet is used as the inquiry packet, and is multicast on a TCP network. An IP address allocated to the digital camera 10 is included in the inquiry packet. The allocation of the IP address will be further described later. When the execution unit 12b receives the inquiry packet, the execution unit 12 transmits a response packet toward the IP address included in the inquiry packet in order to inform the operation unit 10a of the its own position on the network (i.e. the IP address and the port number allocated to the digital camera 12). The IP address and the port number of the digital camera 12 are included in the response packet, and then the operation unit 10a transmits a socket connection request toward the execution unit 12b to attempt to make the socket connection with the execution unit 12b when the operation unit 10a has received the response packet. When the execution unit 12b has accepted the socket connection request, a socket stream is established as a communication path between the operation unit 10a and the execution unit 12b. In the manner mentioned above, the communication between the operation unit 10a of the digital camera 10 and the execution unit 12b of the digital camera 12 is established, and the user of the digital camera 10 can make the digital camera 12 execute a desired function by performing an operation input with the operation unit 10a.

Next, a method of allocating an IP address to each of the multiple digital cameras constituting a group on the network is described. First, number plates are placed before the digital cameras arranged in proximity with each other. Here, the number plates on which numerals “1”, “2” and “3” are written are placed before the multiple digital cameras (e.g. three digital cameras), respectively. Next, the user operates the digital cameras to cause the execution units to execute image capture processing, and make them capture the number plates. Then, the operation unit of each camera obtains from its execution unit the image data obtained by the capture, and executes character recognition processing (e.g. OCR) of the image data. The operation units recognize the numerals “1”, “2” and “3” recognized by the character recognition processing as the host part of the IP address, and store the numerals “1”, “2” and “3” in memory. The actual IP addresses are “169.254.0.1,” “169.254.0.2,” “169.254.0.3,” and the like.

In the following description, it is supposed that an IP address has been given to each digital camera constituting a group in the manner mentioned above, and that a communication path has been established between these digital cameras to enable the control using a PTP command.

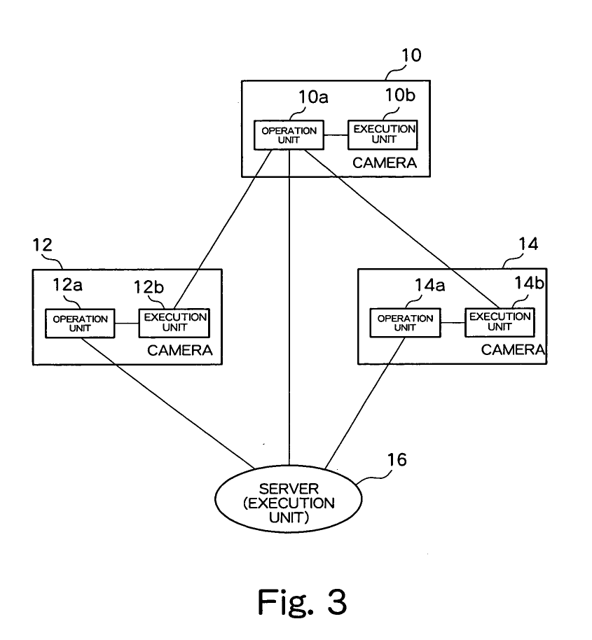

FIG. 3 is system configuration diagram of the present embodiment. It shows a case where multiple cameras; for example, three digital cameras 10, 12, and 14, form a group. An arbitrary digital camera among the three grouped digital cameras 10, 12 and 14 is selected as a master, and the other digital cameras are used as slaves. In this case, the digital camera 10 is used as the master. As described above, the digital camera 10 includes the operation unit 10a, the execution unit 10b, and the communication device 10c. Similarly, each of the other digital cameras 12 and 14 includes an operation unit, an execution unit, and a communication device respectively. A server 16, which the digital cameras 10, 12 and 14 access, also is provided with an execution unit, and this execution unit functions as an execution unit on the Web.

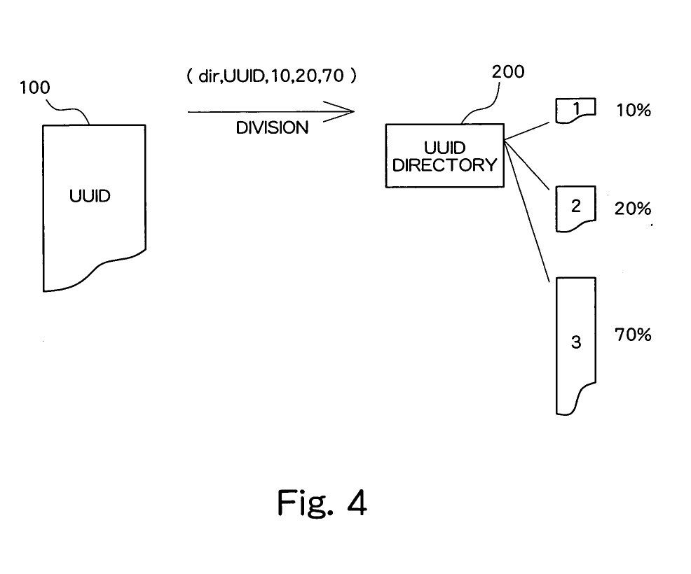

A user operates the operation unit 10a to make a display device such as an LCD or the like display a captured image stored in the memory (an external memory or a built-in memory) of the digital camera 10 to perform browsing, and selects one or more images which should be transmitted to the server 16. Moreover, the operation unit 10a transmits a division command, which is one of the PTP extension commands, to the execution unit 10b (see FIG. 4). In response to the division command, the execution unit 10b divides the selected image into segments which are equal in number to the number of the digital cameras in the group, in accordance with the ratio specified by the division command, and allocates each divided image segment to each digital camera in the group respectively. The three digital cameras 10, 12 and 14 constitute the group in the present embodiment, so the execution unit 10b divides an image into three segments. The division ratio may be equal with three digital cameras, or may be unequal. Preferably, the division ratio is adaptively changed according to the communication capacity or the communication environment of each of the digital cameras 10, 12 and 14. For example, when the total amount of data of the original image is supposed to be 100%, the ratio is: 20% to the digital camera 10, 10% to the digital camera 12, and 70% to the digital camera 14, or the like. After the division of the original image, the operation unit 10a transmits to execution units 12b and 14b of the digital cameras 12 and 14, the image segments allocated to each of the execution units. This image transmission is performed through the first communication method: i.e. WiFi, which is fast but communication distance is limited.

The execution unit 12b of the digital camera 12 receives an image segment transmitted from the digital camera 10, and stores it in a predetermined image storage region. Also, the execution unit 14b of the digital camera 14 receives an image segment transmitted from the digital camera 10, and stores it in a predetermined image storage region. After delivering the image segments to the member cameras 12 and 14 in the group, the operation unit 10a transmits to the server 16 an image segment self-allocated to the digital camera 10, and transmits to the member cameras 12 and 14 a command requesting the member cameras 12 and 14 to transfer the image segments to the server 16. In response to this command (transfer request command), each of the execution units 12b and 14b transfers to the server 16 the image segment allocated itself. These transmissions from the digital camera 10, 12 and 14 to the server 16 are performed through the second communication method, such as public telephone lines or the like, which is slower than the first communication method, but larger communication distance is available than the first communication method. In the manner described above, the original image is divided into three segments, and the divided segments are transmitted from the three digital cameras 10, 12 and 14 simultaneously. Consequently, even when communication is performed with the server 16 through the public telephone lines, the transmission time can be shortened.

In the following, the transmission processing of the present embodiment is described in greater detail. FIG. 4 schematically shows the division operation executed by the newly prepared division command of the PTP. Although an arbitrary file name can be given to the original image file, Universally Unique Identification (UUID) is preferable. The UUID is an identification number unique among the cameras, and can be created by, for example, combining the serial number of a digital camera and the capture time of the original image. Namely, (the UUID of the original image)=(the serial number of the digital camera 10)+(the capture time). The operation unit 10a of the digital camera 10, which is the master, transmits, to the execution unit 10b, a division command (dir, UUID, 10, 20, 70) having an argument composed of a directory (dir) including a device name, the UUID of the original image file to be transmitted after being divided, and a ratio list of the number of the divided segments. Here, “dir” denotes the directory, for example, “A:\DCIM.” “UUID” denotes the UUID of the original image file 100.

The figures “10, 20, 70” denotes a ratio list. When the host parts of the IP addresses of the member cameras constituting the group are denoted as ID1, ID2, and ID3, the ratio list “10, 20, 70” indicates that the ratio of the ID1 is 10%; the ratio of ID2 is 20%; and the ratio of ID3 is 70%. For example, ID 1 denotes the digital camera 12 in FIG. 3; ID2 denotes the digital camera 10 in FIG. 3; and ID3 denotes the digital camera 14 in FIG. 3. The execution unit 10b of the digital camera 10 executes a division operation to produce a “UUID” directory 200 having the same name as the “UUID” of the original image file 100 at a lower hierarchy of the “A:\DCIM” directory of the image file storage region and store the divided three files (files 1-3) under this directory. File 1 is an image segment for ID1, and an image of 10% of the original image; file 2 is an image segment for ID2, and an image of 20% of the original image; and file 3 is an image segment for ID3, and an image of 70% of the original image. The minimum unit of the image division is arbitrary, but, for example, the division is performed by four bytes as the minimum unit. After the production of the three files at the lower hierarchies of the “UUID” directory 200, the operation unit 10a transmits (delivers) the image segments including their directories to the execution units 12b and 14b of the other member cameras constituting the group. Because the digital camera 12 is denoted by ID1 and the digital camera 14 is denoted by ID3, the file 1 is transmitted to the digital camera 12 together with the “UUID” directory, and the file 3 is transmitted to the digital camera 14 together with the “UUID” directory.

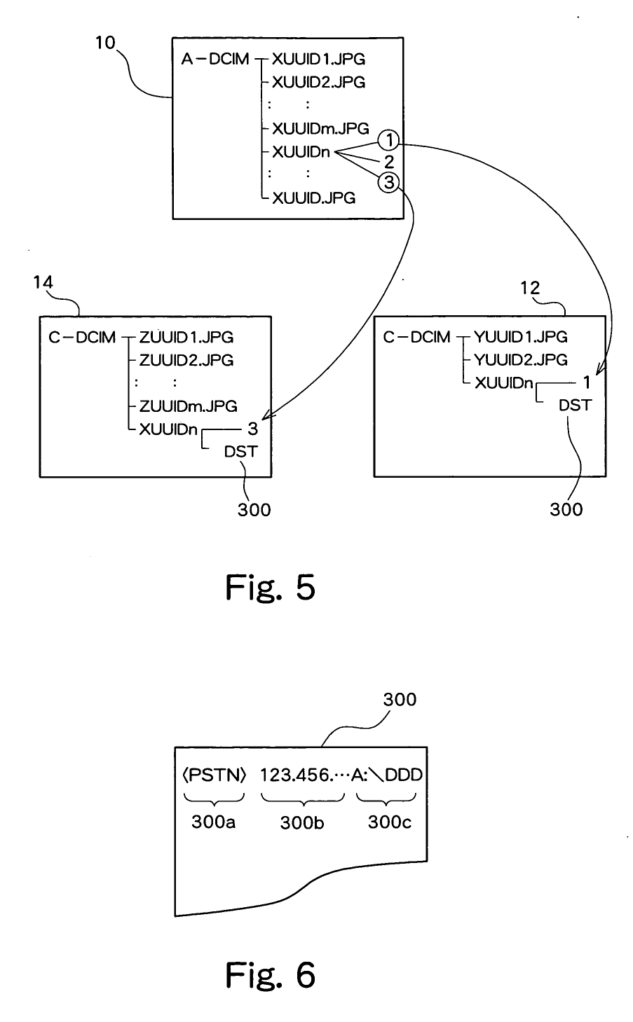

FIG. 5 shows the directory structure of the image file storage region of each of the digital cameras 10, 12 and 14 after the transmission has been performed in the manner described above. When attention is focused on the digital camera 10, which is the master, image files XUUID1.JPG, XUUID2.JPG, . . . XUUIDn.JPG exist at the lower hierarchies of the “A:\DCIM” directory. When it is supposed that the object of the simultaneous segment transmission is the file XUUIDn.JPG, a directory “XUUIDn” having the same name as the “XUUIDn,” which is the UUID of the image file, is produced at a lower hierarchy of the “A:\DCIM” directory, and the files 1, 2, and 3 produced by the division of the original image into three segments are stored in the “XUUIDn” directory. The file 1 is transmitted to the digital camera 12 by a PUT command, which is a PTP command, and the file 3 is transmitted to the digital camera 14. Consequently, in the digital camera 12, which is a slave, the file 1 is stored in the “XUUIDn” directory at the lower hierarchy of “C:\DCIM” directory. In the digital camera 14, the file 3 is stored in the “XUUIDn” directory at the lower hierarchy of the “C:\DCIM” directory. Incidentally, FIG. 5 shows that “DST” files 300 are also stored in the “XUUIDn” directories of the digital cameras 12 and 14 in addition to the files 1 and 3. A “DST” file 300 is a file produced by the digital camera 10, which is the master, and the format is, for example, a text file. The “DST” file 300 is a file describing the information for transmitting an allocated image file. The “DST” files 300 are transmitted to the digital cameras 12 and 14 together with the files 1 and 3 to be stored in the digital cameras 12 and 14, respectively.

The file structure of the “DST” file 300 is shown in FIG. 6. The “DST” file 300 contains three segments of data; a communication method 300a, an IP address 300b, and a directory 300c. In FIG. 6, “PSTN” of the communication method 300a denotes a public telephone circuit. The operation unit 12a of the digital camera 12 and the operation unit 14a of the digital camera 14 transmit image segments through the communication method described in 300a to the transmission destinations 300b and 300c, which are described in the “DST” file 300. The operation unit 12a uses a public telephone line to transmit the image segment data of the file 1 to the directory of the server 16 indicated by the directory 300c, which server 16 is the execution unit mounted on the Web specified by the IP address of “123,456 . . . ,” and also the operation unit 14a uses a public telephone circuit to transmit the data segment of the file 3 to the specified directory of the server 16, which directory is specified by the IP address of “123,456 . . . ” together with the “XUUIDn” directory.

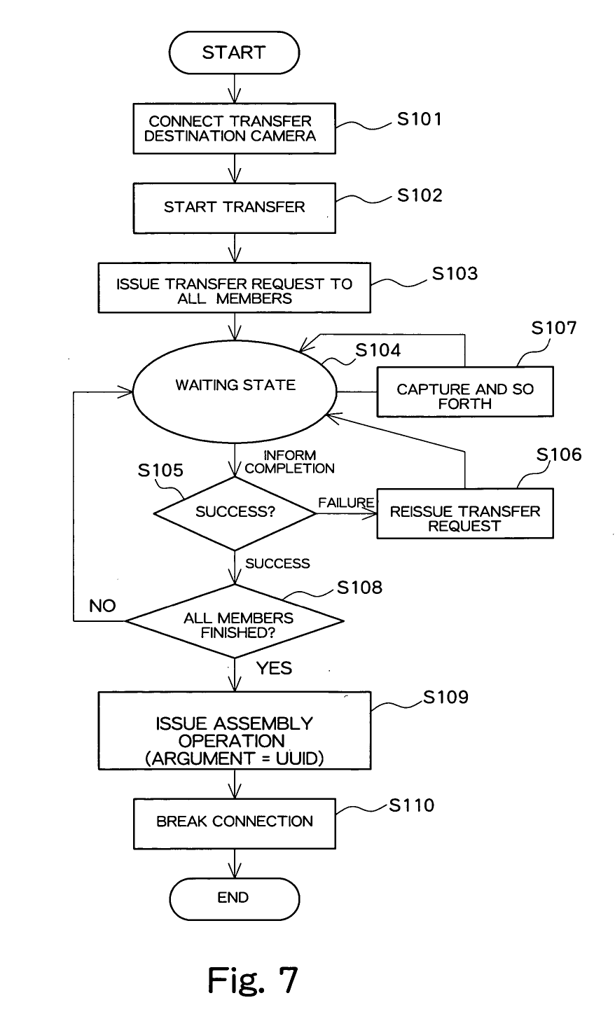

FIG. 7 shows the processing flowchart at the time of the transmission of the digital camera 10, which is the master. First, the digital camera 10, which is the master, establishes communications among the member cameras (transmission destination cameras) in the group by means of WiFi, as described above, and establishes communication with the server 16, which is an execution unit on the Web, with the second communication method; i.e., a telephone line, (Step S101). After executing the division operation, the digital camera 10 starts transferring to the server 16 a file self-allocated to the digital camera 10 (Step S102), and issues a transfer request to the operation units 12a and 14a of all of the member cameras in the group (Step S103). The argument of the transfer request is the UUID of the original image. The transfer request is performed by the communication between operation units using a specific event of the PTP protocol. That is, the specific event has been previously determined. When an operation unit other than the issuing source exists, an execution unit having received the specific event is caused to relay the event to the operation unit. When the execution unit 12b of the digital camera 12 receives the transfer request, the execution unit 12b relays the transfer request to the operation unit 12a. The operation unit 12a opens the “DST” file stored in the “XUUIDn” directory corresponding to the UUID which is the argument of the transfer request, and determines a communication method and a transmission destination execution unit (namely the server 16), and transfers the file. That is, the operation unit 12a tries to establish the connection with the specific execution unit (the server 16) specified by the “DST” file by the specific communication unit, and transfers the file 1 to the specific directory together with the “XUUIDn” directory after establishment of the connection. After completion of the transfer, the operation unit 12a terminates the connection, and transmits a completion notice to the digital camera 10, which is the master, by means of the communication between the operation units. The digital camera 14 operates similarly, and the operation unit 14a opens the “DST” file stored in the “XUUIDn” directory corresponding to the UUID, which is the argument of the transfer request. Then, the operation unit 14a determines a communication method and a transmission destination execution unit, and transfers the file 3 to the transmission destination together with the “XUUIDn” directory. After the completion of transfer, the operation unit 14a transmits a completion notice to the digital camera 10. After issuing the transfer request, the operation unit 10a of the digital camera 10 moves to a waiting state (Step S104). While in the waiting state, the operation unit 10a receives a completion notice from a member camera, and judges whether or not the transfer by the member camera has succeeded (Step S105). When the transfer by the member camera has failed, the operation unit 10a reissues a transfer request to the member camera (Step S106), and moves to the waiting state again. Because the transfer processing including the self transmission is performed asynchronously, the operation unit 10a may perform other processing, such as capture processing, while waiting (Step S107). The processing described above is executed repeatedly until it is judged that the transfers by all the member cameras have succeeded (Step S108).

When the transfers by all of the member cameras have been completed, the operation unit 10a issues an assembling command to the server 16, and commands the server 16 to assemble the original image file, which has been divided and has been transmitted, to store the original image file in a memory (Step S109). The assembling operation is a reverse operation of the division operation mentioned above, and is the processing of synthesizing the files 1, 2, and 3 to reconstruct one original image. Because each file is stored in the “XUUIDn” directory at the lower hierarchy of the “A:\DDD” directory, the server 16 sequentially combines each file to produce the original image XUUIDn.JPG, and stores the produced original image XUUIDn.JPG in a lower hierarchy of the “A:\DDD” directory. After having assembled the original image, the server 16 deletes the “UUIDn” directory and the files 1, 2, and 3, because they are no longer necessary. As described above, the original image XUUIDn.JPG is stored at the lower hierarchy of the desired “A:\DDD” directory of the server 16. Subsequently, the digital camera 10, which is the master, breaks the connections with the server 16 and the member cameras to end the processing (Step S110).

Although in the present embodiment the communications in the digital cameras 10 and 12 and 14 have been set to WiFi, other communication protocols, such as Bluetooth, can be adopted. Moreover, although the case where the image captured by the digital camera 10 has been transmitted to the server 16 has been described, data other than image data, such as sound data, may be transmitted to the server 16. Furthermore, although digital cameras have been exemplified in the present embodiment, the present invention can be applied to the other communication equipment, such as a cellular phone and a PDA.

The first embodiment has described the case where the multiple digital cameras have been grouped, an image is divided into segments, and the member cameras simultaneously transmit to the server 16 the segments of the image self-allocated to the member cameras themselves. The present embodiment describes the case where an image stored in the server 16 is received by multiple digital cameras in the state of being divided.

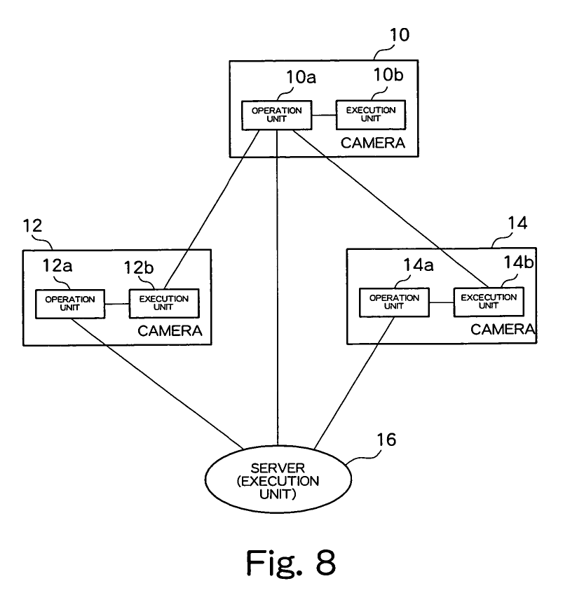

FIG. 8 shows the system configuration diagram of the present embodiment. Similar to the case shown in FIG. 3, a case where three digital cameras 10, 12, and 14 form a group is shown. Each camera has an operation unit, an execution unit, and a communication device. The operation unit 10a of the digital camera 10, which is a master, specifies an image which should be received (downloaded) among the images stored in the server 16, which is an execution unit on the Web (a user operates the operation unit 10a to browse an image stored in the server 16, and performs the selection input of the image which should be received), and issues a division command to the server 16 for the specified image file. The server 16, which has received the division command, produces a “UUIDn” directory having the same name as that of an image UUIDn.JPG to be an object, as described in detail in the first embodiment, and the server 16 stores the files 1, 2, and 3 divided into the “UUIDn” directory by the number which is equal to the number of the member cameras in a group. After the division, the operation unit 10a receives the file 2 allocated to the operation unit 10a from the server 16 by a GET command of PTP, and issues, to each of the operation units 12a and 14a, a transfer request command, which is a communication operation between operation units, and uses the UUID of the original image as the argument which should be received. In accordance with the transfer request, the operation units 12a and 14a receive the respective files 1 and 3 from the server 16 by a GET command, which is a PTP command, respectively. The operation units 12a and 14a, which have received the image segments from the server 16, use the communication between operation units to transmit completion notices to the operation unit 10a. The operation unit 10a issues a GET command to each of the execution units 12b and 14b in response to the completion notices, and receives the files 1 and 3. In the manner mentioned above, all the division files 1, 2, and 3 of the original image are received by the digital camera 10, and the execution unit 10b executes the assembling operation according to an assembly command from the operation unit 10a.

In the following, the segment reception processing of the present embodiment is described in more detail. Incidentally, the original image, which is stored in the server provided with an execution unit and is to be downloaded, is assumed to be UUIDm.JPG.

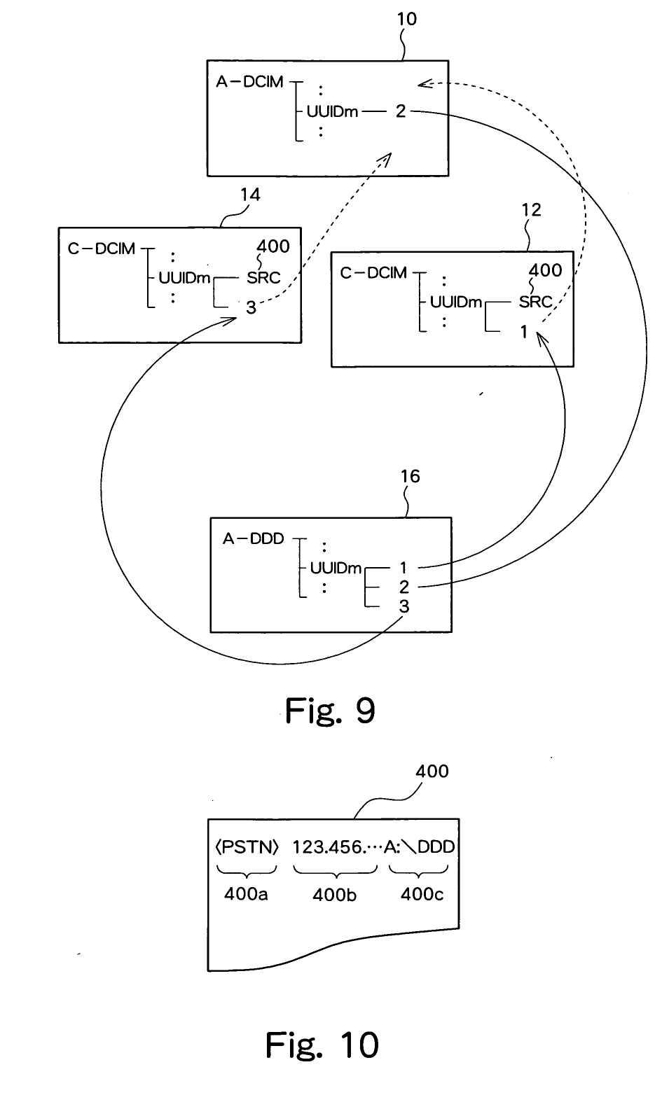

The directory structures of the digital cameras 10, 12 and 14 and the server 16 provided with the execution units are shown in FIG. 9. The operation unit 10a of the digital camera 10, which is a master, issues a division command to the server 16. The division command includes the UUID of the original image and a ratio list of each of member cameras. In response to the division command, the server 16 produces a “UUIDm” directory having the same name as that of the UUID of the original image at a lower hierarchy of an “A:\DDD” directory, and stores in the directory files 1, 2, and 3, which have been produced by dividing the original image into three segments. The ratio of the files 1, 2, and 3 is determined by the ratio list. Moreover, the operation unit 10a produces another “UUIDm” directory having the same name as that of the original image in each of the execution units 12b and 14b, and stores “SRC” files 400 in the “UUIDm” directories. The “SRC” file 400 is a file corresponding to the “DST” file 300 in FIG. 6, and as shown in FIG. 10, the “SRC” file 400 includes a communication method 400a, the IP address 400b of the server 16, and a directory 400c.

Next, the operation unit 10a issues a transfer request to each of the operation units 12a and 14a by means of the communication between the operation units, and receives from the server 16 the file 2 self-allocated to the digital camera 10. The operation units 12a and 14a of the digital cameras 12 and 14, which have received the transfer requests, open the “SRC” files 400 stored in the “UUIDm” directories, the names of which are the same as that of the UUID, which is the argument of a transfer request, to thereby determine communication methods and IP addresses. Then, the execution units 12b and 14b establish communications with the server 16, and receive from the server 16 the respective segments allocated thereto. The operation unit 12a receives the file 1, and the operation unit 14a receives the file 3. After having obtained the files 1 and 3 from the server 16, the operation units 12a and 14a transmit completion notices to the operation unit 10a. Upon receipt of the completion notices from the operation units 12a and 14a, the operation unit 10a subsequently obtains these files from the execution units 12b and 14b. After that, the operation unit 10a issues to the execution unit 10b an assembling command using the UUID as the argument. Because the file 2 obtained from the server 16 by itself and the files 1 and 3 obtained from the server 16 via the digital cameras 12 and 14 are stored in the “UUIDm” directories, the execution unit 10b combines these files 1, 2, and 3 one by one to thereby reconstruct the original image called UUIDm.JPG, and stores the original image in an “A:\DCIM” directory. The three files 1, 2, and 3 stored in the “UUIDm” directory in the server 16 are deleted when the reception has succeeded.

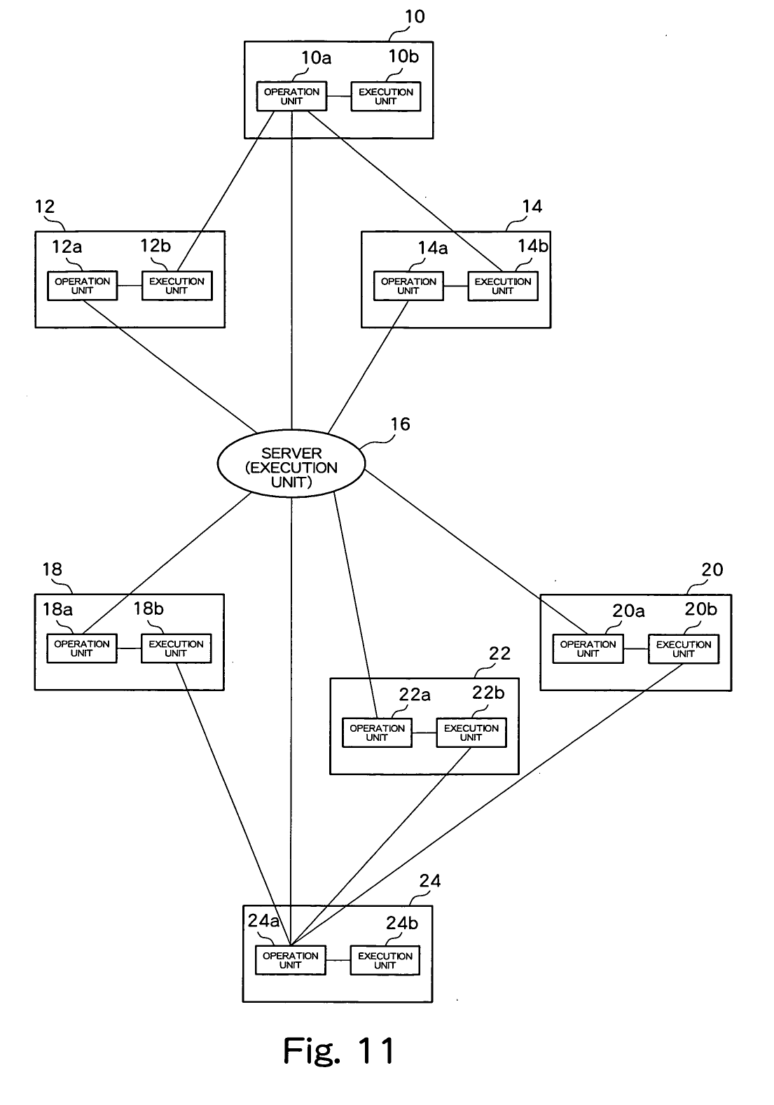

FIG. 11 is a system configuration diagram of a third embodiment is. In the first embodiment, the segment simultaneous transmission (segment simultaneous upload) of an image to the server 16 has been described. In the second embodiment the segment simultaneous reception (segment simultaneous download) from the server 16 has been described. In the present embodiment, the case where the segment simultaneous transmission and the segment simultaneous reception are combined is described.

Three digital cameras 10, 12 and 14 constitute a group G1, and four digital cameras 18, 20, 22, and 24 constitute a group G2. The group G1 is configured to use the digital camera 10 as a master and to use the digital cameras 12 and 14 as slaves. In the group G1, a captured image stored in the memory of the digital camera 10 is subjected to the segment simultaneous transmission to the server 16 by means of the process shown in the first embodiment. After the segment simultaneous transmission, the operation unit 10a issues an assembling command to the server 16, and the server 16 sequentially combines the three files 1, 2, and 3 stored in the “UUIDn” directory at the lower hierarchy of an “A:\DOD” directory in accordance with the command to reconstruct the original image UUIDn.JPG. The original image is stored in the “A:\DOD” directory.

Meanwhile, the group G2 is configured to use the digital camera 24 as a master and to use the digital cameras 18, 20 and 22 as slaves. In the group G2, the original image stored in the server 16 is subjected to the segment transmission to the digital camera 24 by the process shown in the second embodiment. That is, the operation unit 24a of the digital camera 24 issues a division command to the server 16, and divides an original image UUIDn.JPG into the image segments which are equal in number to the four digital cameras. The division ratio is in accordance with the ratio list of the division command; for example, the original image is divided into the segments of files 1-4 each having the same size (25% of the whole). Moreover, the “UUIDn” directory is produced in each of the digital cameras 18, 20 and 22, and the “SRC” file is stored in each “UUIDn” directory. The “SRC” file describes a communication method, the IP address of the server 16, and a directory. The UUID of an image to be downloaded may be supplied by means of, for example, electronic mail from the operation unit 10a of the digital camera 10, which is the master of the group G1, to the operation unit 24a of the digital camera 24, which is the master of the group G2.

The operation units 18a, 20a, and 22a of the digital cameras 18, 20, and 22 determine communication methods, IP addresses, and directories by referring to the “SRC” files stored in the “UUIDn” directories in accordance with the transfer requests issued from the operation unit 24a, and obtain the files allocated to the digital cameras 18, 20, and 22 from the server 16. When the operation units 18a, 20a, and 22a have obtained the files allocated to the digital cameras 18, 20, and 22, respectively, the operation units 18a, 20a, and 22a transmit completion notices to the operation unit 24a. Upon receipt of the completion notices from the digital cameras 18, 20 and 22, the operation unit 24a receives files from the execution units 18b, 20b, and 22b of the respective digital cameras 18, 20, and 22 by GET commands, and receives the total four files 1, 2, 3, and 4 including the file obtained from the server 16 itself. Because the files 1-4 are dividedly stored in the “UUIDn” directory of the execution unit 24b in such a manner, the operation unit 24a issues an assembling command to the execution unit 24b, and the execution unit 24b sequentially combines the files 1, 2, 3, and 4 stored in the “UUIDn” directory to reconstruct the original image UUIDn.JPG. The “UUIDn” directory of the server 16 and the “UUIDn” directory of the execution unit 24b are deleted after successful reception. The processing mentioned above enables a short-time transmission from the digital camera 10 to the digital camera 24 via the server 16.

Although the embodiments of the present invention have been described above, the present invention is not limited to the embodiments, and other modes are also possible. For example, although in the embodiments the operation unit 10a of the digital camera 10 reissues transfer requests when the segment transmissions by the member cameras 12 and 14 have failed at the time of segment transmissions (Step S106 in FIG. 7), it is also suitable to store the number of retries to attempt after a certain time when the number has reached a certain value.

Moreover, after segment simultaneous reception, the operation unit 10a of the digital camera 10, which is the master, may deliver the original image, which has been received and reconstructed, to the member cameras 12 and 14. Thereby, all the digital cameras 10, 12, and 14 in a group share the original image. By performing the segment reception in communication methods having low speeds, and by transferring images as they are in communication methods having high speeds, the images can be commonly owned in an efficient manner.

Moreover, although each embodiment described above is configured to make the digital cameras 12, 14, and the like, which are slaves, transfer the files as they are from the digital camera 10, which is the master, or the server 16, a configuration enabling the slaves to add peculiar data to the files may be adopted. For example, in the case where the divided image files are transferred in forms by which the image files can be edited, a user displays the images on a monitor of the slave camera to input characters or the like with a touch pen or the like on the screen. Then, the user adds the input character images, their coordinate position data, and the like to the file of the original images to thereby transfer them. On the side of the server, the image synthesis also including the added data is performed. Thereby, an image file can be effectively shared among the users of the same group. For realizing the system, it is necessary that the slaves do not immediately enter their transfer operations even when a transfer request from a master side has come, and that the slaves execute the transfer operations only when users permit the transfers. In this case, if the master is set to issue a transfer request to each of the slaves only when the master detects that all the slaves have changed into the transmission-permitted states, useless communications can be prevented and efficient data transmission can be performed. Incidentally, it is also admittable to set a slave in the transfer-permitted state thereof when the user of the slave does not have the intention of adding any data.

What is claimed is:

1. A data transmitter which transmits to a server data stored in a memory, comprising:
a divider which divides the data into segments which are equal in number to the number of data transmitters including the data transmitter itself and other grouped data transmitters; and
a transmission controller which causes the data transmitter to transmit to each of the other data transmitters a segment of data allocated thereto respectively using a first communication method, causes the data transmitter itself to transmit a segment of data allocated thereto to the server using a second communication method, and transmits to the other data transmitters a command signal which requests each of the other data transmitters to transmit to the server the segment of data transmitted thereto using the second communication method.

2. The data transmitter according to claim 1, wherein
the transmission controller transmits to the other data transmitters a file regulating a method of data transmission to the server and information for specifying the server; and
the other data transmitters are connected to the server by referring to the file when the other data transmitters receive the command signal.

3. The data transmitter according to claim 1, further comprising a capturing unit which captures a subject, wherein
the data are captured image data.

4. The data transmitter according to claim 1, wherein
the divider divides the data at variable ratios to the data transmitter itself and the other data transmitters.

5. The data transmitter according to claim 1, wherein
a UUID is given to a file name of the data;
the divider stores the divided data in a lower hierarchy of a directory having the same name as that of the UUID in the memory; and
the transmission controller transmits the data allocated to the other data transmitters together with the directory.

6. A data receiver which receives data stored in a server, comprising:
a division request unit which requests the server to divide the data into segments which are equal in number to the number of data receivers including the data receiver itself and other grouped data receivers; and
a reception controller which causes the data receiver itself to obtain from the server a segment of data allocated thereto, transmits, to each of the other data receivers, a command signal which requests each of the other data receivers to obtain the segment of data allocated thereto from the server, and obtains from each of the other data receivers, the segment of data obtained by each of the other servers in accordance with the command signal, wherein
a first communication method is used at the time of obtaining the segments of data from the other data receivers, and a second communication method is used at the time of obtaining from the server the segment of data self-allocated to the data receiver itself.

7. The data receiver according to claim 6, wherein
the reception controller transmits to the other data receivers a file regulating a method for data reception from the server and information for specifying the server; and
the other data receivers are connected to the server by referring to the file when the data receivers receive the command signal.

8. A data transmission system which transmits data to a server by means of a plurality of data transmitters, wherein
any of the plurality of data transmitters is used as a master, and the other data transmitters are used as slaves;
the master includes:
a divider which divides the data into segments which are equal in number to the number of data transmitters including the master and the slaves; and
a master side transmission controller which causes the master to transmit to each of the slaves a segment of data divided by the divider and allocated thereto respectively using a first communication method, causes the master to transmit a segment of data allocated thereto to the server using a second communication method, and transmits to the slaves a command signal which requests each of the slaves to transmit to the server the segment of data transmitted thereto; and
each of the slaves includes:
a slave side storage unit which stores a segment of data allocated by the master; and
a slave side transmission controller which causes the slave to transmit, to the server, the data stored in the slave side storage using the second communication method in accordance with the command signal transmitted from the master.

9. The data transmission system according to claim 8, wherein
the data transmitters are digital cameras.

10. A data reception system which receives data from a server by means of a plurality of data receivers, wherein
any of the plurality of data receivers is used as a master, and the other data receivers are used as slaves;
the master includes:
a division request unit which requests the server to divide the data into segments which are equal in number to the number of data receivers including the master and the slaves; and
a reception controller which transmits to each of the slaves, using a first communication method, a command signal which requests each of the slaves to obtain a segment of data allocated thereto from the server, causes the master to receive, using the first communication method, the segment of data which each of the slaves has received from the server in accordance with the command signal, and causes the master to receive, using a second communication method, a segment of data self-allocated to the master which has been transmitted from the server; and
each of the slaves includes:
a slave side storage unit which stores a segment of data received from the server using the second communication method in accordance with the command signal.

11. The data reception system according to claim 10, wherein
the data receivers are digital cameras.

12. A data transmission method which transmits data to a server by means of a plurality of data transmitters, comprising the steps of:
using any of the plurality of data transmitters as a master, and dividing the data to be transmitted into segments which are equal in number to the number of the plurality of data transmitters to thereby allocate a segment of the data to each of the data transmitters;
the master transmitting to each of the data transmitters other than the master a segment of data allocated thereto using a first communication method and transmitting a segment of data self-allocated to the master to the server using a second communication method; and
each of the data transmitters other than the master transmitting using the second communication method, to the server, the segment of data which has been allocated to the data transmitter and has been received from the master.

13. A data reception method which receives data from a server by means of a plurality of data receivers, comprising the steps of:
using any of the plurality of data receivers as a master and requesting the server to divide the data into segments which are equal in number to the number of the data receivers including the master and slaves; and
the master receiving using a first communication method, from each of the data receivers other than the master, a segment of data which has been received from the server, and receiving, from the server, a segment of data self-allocated to the master using a second communication method.

14. A terminal device which can transmit and receive data with a server, comprising:
a master slave setting unit which sets a self terminal device as either of a master and a slave in a group together with a plurality of other terminal devices;
a divider which divides the data into segments which are equal in number to the number of terminal devices including the self terminal device and the other grouped terminal devices when the self terminal device is the master;
a transmission controller which causes the self terminal device to transmit to each of the other terminal devices a segment of data divided by the divider and allocated thereto respectively, causes the self terminal device to transmit a segment of data allocated thereto to the server, and transmits to the other terminal devise a command signal which requests each of the other terminal devices to transmit to the server the segment of data allocated thereto; and
a data relay unit which receives data from the master terminal device when the self terminal device is a slave, and transmits the received data to the server at the time of receiving the command signal.

15. The terminal device according to claim 14, further comprising a data addition unit which newly adds data to the data received from the master terminal device to thereby transmit the added data to the server.

16. A terminal device which can transmit and receive data to and from a server, comprising:
a master slave setting unit which sets the self terminal device as either of a master and a slave in a group together with a plurality of other terminal devices;
a division request unit which requests the server to divide the data into segments which are equal in number to the number of terminal devices including the self terminal device and the other grouped terminal devices when the self terminal device is the master;
a reception controller which causes the self terminal device to obtain from the server a segment of data allocated to the self terminal device, outputs a command signal which requests each of the other terminal devices to obtain from the server the segment of data allocated thereto, and causes the self terminal device to obtain the segments of data obtained by the other terminal devices in accordance with the command signal from the other terminal devices; and
a data relay unit which obtains from the server a segment of data allocated to the self terminal device at the time of receiving the command signal from the master terminal device, and transmits the obtained segment of data to the master terminal device when the self terminal device is the slave.
